(19) United States
(12) Patent Application Publication
(10) Pub. No.: US 2011/0222121 A1
(43) Pub. Date: Sep. 15, 2011

(54) INFORMATION PROCESSING APPARATUS, IMAGE FORMING APPARATUS, AND INFORMATION PROCESSING METHOD

(76) Inventor: Makoto ODAMAKI, Kanagawa (JP)

(21) Appl. No.: 13/041,628

(22) Filed: Mar. 7, 2011

(30) Foreign Application Priority Data
Mar. 12, 2010 (JP) 2010-056165

(51) Int. Cl. G06K 15/00

(52) U.S. Cl. 358/1.16

(57) ABSTRACT

An information processing apparatus includes: a storage unit which stores first image data including a plurality of pixel data; a control unit which is connected to the storage unit and which performs a calculation process on the first image data and controls performing of the calculation process; a parallel calculation process unit which simultaneously performs the same calculation processes on entirety of or some of the plurality of the pixel data included in the first image data; and a sequential calculation process unit which performs the calculation process on each of the pixel data included in the first image data, wherein the control unit determines, as a calculation performer to perform a first calculation process, at least one unit selected from a group including the control unit itself, the parallel calculation process unit, and the sequential calculation process unit, according to a predetermined condition.

### CROSS-REFERENCE TO RELATED APPLICATIONS

The present application claims priority to and incorporates by reference the entire contents of Japanese Patent Application No. 2010-056165 filed in Japan on Mar. 12, 2010.

### BACKGROUND OF THE INVENTION

1. Field of the Invention

The present invention relates to an information processing apparatus, an image forming apparatus, and an information processing method.

2. Description of the Related Art

Nowadays, a digital multi-function machine referred to as an MFP (Multi Function Peripheral) combining, for example, a copier function, a facsimile (FAX) function, a printer function, and a scanner function, and the like, has been provided as an information processing apparatus. According to the digital multi-function machine, hand-written manuscripts on documents or papers can be computerized to generate image data, and the image data can be shared and utilized in a network. Recently, image processing or information processing has been performed on image data. More specifically, there are a complex compressing process (highly compressed PDF), Optical Character Recognition (OCR), buried code detection, automatic rotation, and the like. In general, the computerized image data of a paper manuscript has a large size. For example, an “A4300 dpi 8-bit” full-color manuscript has a size of about 25 MB in an uncompressed state. Due to the large size thereof, a large processing amount is needed for the image processing on the image data. In the case where the image process on the large size of the image data is performed by only the CPU (central processing unit) as a general controller included in the digital multi-function machine, the image processing may not be completed within a user's desired time. In order to perform the image processing at high speed, an auxiliary calculation process apparatus (accelerator) may be used in more cases than before. As the auxiliary calculation process apparatus, there are an FPGA, an SIMD, a reconfigurable processor, a DSP, and the like. In addition, an image forming apparatus having a parallel calculation processing unit and a sequential calculation processing unit, which are used for the purpose of performing the entire image processing at high speed and are capable of implementing the processing with appropriate calculation process resources by using these units, has been developed (refer to Japanese Patent No. 3,887,134).

In the technology of Japanese Patent No. 3,887,134, the parallel calculation processing unit and the sequential calculation processing unit are connected to a CPU through a CPU/IF. However, this configuration is provided for the purpose of control. The image data of the processing object are not transmitted from the CPU to the parallel calculation processing unit and the sequential calculation processing unit, but the image data of the processing object are transmitted through an internal interface to the parallel calculation processing unit and the sequential calculation processing unit. In the technology of Japanese Patent No. 3,887,134, in the case of performing a calculation process that can be performed in simple sequence in a hardware manner, the entire image processing can be performed at high speed. However, in the case of a complex calculation process having, for example, branches or loops or various calculation processes, which are dedicated to a CPU, in a software manner, it is difficult to perform the entire image processed at high speed.

### SUMMARY OF THE INVENTION

It is an object of the present invention to at least partially solve the problems in the conventional technology.

According to an aspect of the present invention, there is provided an information processing apparatus including: a storage unit which stores first image data including a plurality of pixel data; a control unit which is connected to the storage unit and which performs a calculation process on the first image data and controls performing of the calculation process; a parallel calculation process unit which simultaneously performs the same calculation processes on entirety of or some of the plurality of the pixel data included in the first image data; and sequential calculation process unit which performs the calculation process on each of the pixel data included in the first image data, wherein the control unit determines, as a calculation performer to perform a first calculation process, at least one unit selected from a group including the control unit itself, the parallel calculation process unit, and the sequential calculation process unit, according to a predetermined condition.

According to another aspect of the present invention, there is provided an image forming apparatus including: the information processing apparatus according to the mentioned-above; and an image forming unit which forms an image on a printing medium by using the second image data, which is the resulting data from the calculation process.

According to still another aspect of the present invention, there is provided a method of processing information performed by an information processing apparatus including: a storage unit which stores image data including a plurality of pixel data, a control unit which is connected to the storage unit and which can perform a calculation process on the image data and controls the performing of the calculation process, a parallel calculation process unit which simultaneously performs the same calculation processes on the entire or some of the plurality of the pixel data included in the image data, and a sequential calculation process unit which performs the calculation process on each of the pixel data included in the image data, the method including: allowing the control unit to determine at least one out of the control unit, the parallel calculation process unit, and the sequential calculation process unit, as a calculation performer to perform the first calculation process according to a predetermined condition.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating an overview of a configuration of an image processing apparatus according to a first embodiment;

FIG. 2 is a view illustrating a hardware configuration of a high-speed calculation unit;

FIG. 3 is a view illustrating an example of calculation process information;

FIG. 4 is a flowchart illustrating a procedure of processing performed by the high-speed calculation unit;

FIG. 5 is a schematic view illustrating timings of a calculation process performed by a CPU, a calculation process performed by a sequential calculation processing unit, and a calculation process performed by a parallel calculation processing unit;

FIG. 6 is a view illustrating a hardware configuration and a functional configuration of a high-speed calculation unit according to a second embodiment;

FIG. 7 is a flowchart illustrating a procedure of a calculation site determination process;

FIG. 8 is a view illustrating a hardware configuration of a high-speed calculation unit 51 according to a third embodiment;

FIG. 9 is a view illustrating a parallel signal;

FIG. 10 is a flowchart illustrating a procedure of processing performed by a high-speed calculation unit;

FIG. 11 is a schematic view illustrating timings of a calculation process performed by a CPU, a calculation process performed by a sequential calculation processing unit, and a calculation process performed by a parallel calculation processing unit;

FIG. 12 is a flowchart illustrating a procedure of processing performed by a high-speed calculation unit according to a modification of the embodiment.

### DETAILED DESCRIPTION OF THE PREFERRED EMBODIMENTS

Hereinafter, information processing apparatuses, image forming apparatuses, and information processing methods according to embodiments of the present invention will be described in detail with reference to the accompanying drawings.

### First Embodiment

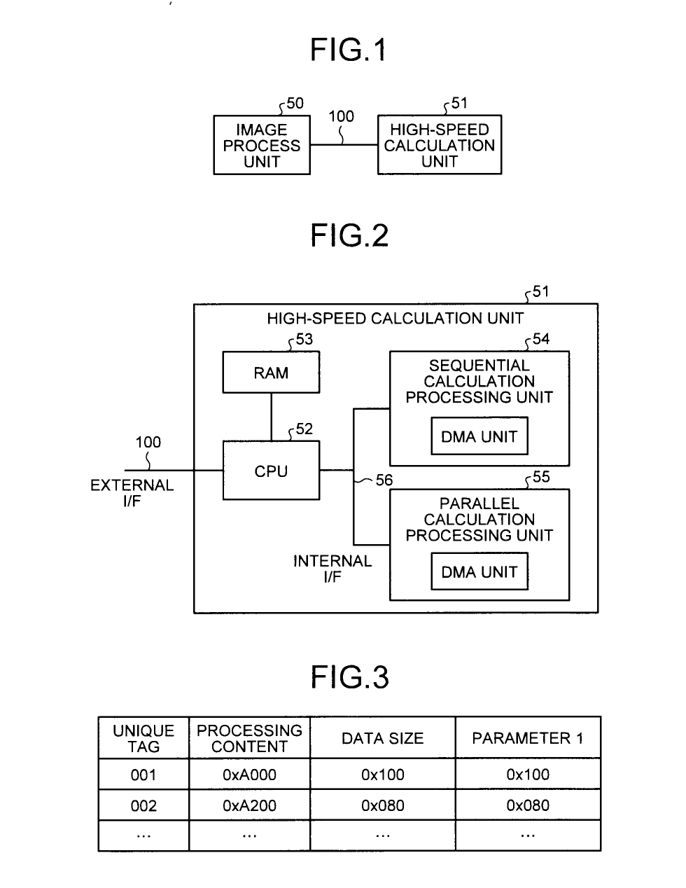

The overview of a configuration of an image forming apparatus employing a high-speed calculation unit, which is an information processing apparatus according to an embodiment, is described with reference to FIG. 1. The image forming apparatus is configured to include an image processing unit 50 and a high-speed calculation unit 51, which are connected to each other through an external I/F 100. The image processing unit 50 includes: an image reading unit which reads an image from a document and generates image data representing the image; and an image forming unit which forms the image on a printing medium by using the image data after the high-speed calculation unit performs a calculation process. The high-speed calculation unit 51 serves as an image processing accelerator that performs a calculation process on the image data generated by the image reading unit. The external I/F 100 is preferably configured so as to be detachable to the high-speed calculation unit 51. In addition, the external I/F 100 is preferably configured as a high-speed I/F. However, transmission of image data of a processing object and a calculation process in the high-speed calculation unit 51 can be performed in parallel (in a pipeline manner), so that the external I/F 100 may be configured as a low speed I/F as long as it does not cause a bottleneck in terms of a transmission time. Furthermore, the detailed configuration of the image forming apparatus is disclosed in, for example, Japanese Patent No. 3,887,134, the description thereabout is not given here.

Next, a hardware configuration of the high-speed calculation unit 51 is described with reference to FIG. 2. The high-speed calculation unit 51 according to the embodiment includes a CPU 52, a Random Access Memory (RAM) 53, a sequential calculation processing unit 54, and a parallel calculation processing unit 55. The CPU 52, the sequential calculation processing unit 54, and the parallel calculation processing unit 55 are connected through an internal I/F 56. The CPU 52 and the RAM 53 are connected through an internal bus. The RAM 53 stores various data or various programs. The image processing unit 50 is connected to the CPU 52 through the external I/F 100.

If the image data and a command for instructing image processing on the image data are transmitted from the image processing unit 50 through the external I/F 100, the CPU 52 receives the input of the image data and the command and executes various programs stored in the RAM 53, so that the image processing including various calculation processes is performed on the image data. The image data includes pixel data representing each of a plurality of pixels. The calculation processes of the image processing include, for example, a shading correction process (a process of correcting an irregularity of a luminance distribution of a light source in the image reading unit), a scanner y correction process (a process of correcting a concentration characteristic of the image reading unit), an MTF correction process, a smoothening process, a main scan directional arbitrary magnification process, a concentration conversion process(y conversion process: corresponding to concentration notch), a simple multi-value process, a simple binarization process, an error diffusion process, a dither process, a dot array phase control process (right-sided dot and left-sided dot), an isolated point removing process, an image area separation process (color determination, attribute determination, and adaptation processes), a density conversion process, an image composing process, an image shift process (image shift in main and sub scan directions), an image area expending process (capable of expending an image area by an arbitrary amount in the vicinity thereof), an image magnification process (for example, fixed magnification of 50% or 200%), an image-quality adjusting process, and the like. These calculation processes may be simultaneously performed on a plurality of pixel data included in the image data or on each of the pixel data in a pipeline manner. In addition, each of the calculation processes is allocated by, for example, a calculation process number.

Herein, a method of controlling the image processing by the CPU 52 is described in detail. The CPU 52 transmits a program for performing various calculation processes to the sequential calculation processing unit 54 and the parallel calculation processing unit 55 through the internal I/F 56. Furthermore, if the program is transmitted before the calculation process is performed, the program may be transmitted at the time of driving the high-speed calculation unit 51 or just before the calculation process is performed. However, in order to reduce the transmission time, it is preferable to transmit the program at the time of driving the high-speed calculation unit 51. Next, the CPU 52 determines a calculation performer to perform the calculation process of the image processing, which is subjected to a command for performing, according to a predetermined condition. In other words, the CPU 52 determines the calculation performer, that is, one of the CPU 52, the sequential calculation processing unit 54, and the parallel calculation processing unit 55. In the image processing optimized for the CPU, the calculation processes are basically performed by the CPU 52. However, some of the calculation processes which can be performed at higher speed by the sequential calculation processing unit 54 or the parallel calculation processing unit 55 than by the CPU may be performed any one of the sequential calculation processing unit 54 and the parallel calculation processing unit 55. For each calculation process, it may be determined, through pre-validation, which of the CPU 52, the sequential calculation processing unit 54, and the parallel calculation processing unit 55 can perform the calculation process at highest speed. Alternatively, the determination may be performed while the image processing is performed. In the embodiment, the determination is performed through pre-validation, and a table listing calculation processes and the corresponding performs to perform the calculation processes are stored in the RAM 53 in advance, in which each calculation performer is one of the CPU 52, the sequential calculation processing unit 54, and the parallel calculation processing unit 55. For example, a calculation process correspondence table is stored in the RAM 53 in which, for each calculation process, a calculation process number is listed, corresponding to calculation performer information which refers to one of the CPU 52, the sequential calculation processing unit 54, and the parallel calculation processing unit 55 to perform the corresponding calculation process. For the given calculation process of the image processing which is commanded to be performed, the CPU 52 determines, with reference to the calculation process correspondence table, a calculation performer to perform the calculation process by selecting any one from the CPU 52, the sequential calculation processing unit 54, and the parallel calculation processing unit 55 indicated by the calculation performer information that corresponds to the calculation process number of each calculation process. In other words, in the embodiment, the predetermined condition such that which unit can perform the calculation at the highest speed is set in advance, and thus the calculation performer to perform the calculation process is determined according thereto. Next, if the sequential calculation processing unit 54 is determined as the calculation performer, the CPU 52 transmits the calculation process information indicating the content of the calculation process to the sequential calculation processing unit 54 through the internal I/F 56, and if the parallel calculation processing unit 55 is determined as the calculation performer, the CPU 52 transmits the calculation process information indicating the content of the calculation process to the parallel calculation processing unit 55 through the internal I/F 56.

FIG. 3 is a view illustrating an example of the calculation process information. As illustrated in the figure, the calculation process information represents a calculation process number, a code indicating the content of a calculation process, a data size of image data of a processing object, and a parameter used at the time of the calculation process. The parameter is used for the case where the calculation process is, for example, an image-quality adjusting process.

Returning to FIG. 2, the description continues to be. After the completion of the calculation process is notified from the parallel calculation processing unit 55 through the internal I/F 56, or after the completion of the calculation process is notified from the sequential calculation processing unit 54 through the internal I/F 56, if it is determined such that the entire image processing is completed, the CPU 52 transmits the calculation-resulting image data stored in the RAM 53 to the image processing unit 50 through the external I/F 100. As a result, in the image forming unit included in the image processing unit 50, an image is formed on a printing medium by using the image data.

The parallel calculation processing unit 55 is a calculation process circuit which performs a calculation process in a Single Instruction Multiple Data stream (SIMD) manner. The parallel calculation processing unit 55 has an Arithmetic Logic Unit (ALU), a Direct Memory Access (DMA) unit, and a storage unit. The storage unit stores various programs for allowing the parallel calculation processing unit 55 to perform a calculation process on the image data. The program is transmitted from the CPU 52 through the internal I/F 56. In addition, the storage unit stores a parallel calculation process ability table listing calculation processes which can be performed by the parallel calculation processing unit 55. For example, the parallel calculation process ability table lists calculation numbers of the calculation processes which can be performed by the parallel calculation processing unit 55 and acceptability states indicating whether or not the calculation processes can be accepted in a correspondence manner. For example, the state where the calculation process cannot be accepted is a state where the parallel calculation processing unit 55 has already been performing a calculation process and other calculation processes cannot be performed. The DMA unit accesses the RAM 53 without intervention of the CPU 52 to read the image data stored in the RAM 53 or to write the result (calculation result) of the calculation performed by the ALU in the RAM 53. The n ALUs are connected in parallel to m sets of register files, in which one set includes n registers. The ALU is input with the pixel data for two pixels among the pixel data included in the image data read by the DMA unit, and the ALU performs calculation such as addition, subtraction, multiplication, division, and logic calculation process on the pixel data. At this time, the n ALUs simultaneously perform the same calculation according to one command. Next, the ALU writes the calculation result back in the register file. In this configuration, if the parallel calculation processing unit 55 receives the calculation process information transmitted through the internal I/F 56 by the CPU 52, the parallel calculation processing unit 55 determines, with reference to the parallel calculation process ability table, whether or not the calculation process of the calculation number indicated by the calculation process information can be performed and whether or not the calculation process can be received. In the case where the result of determination is affirmative, the parallel calculation processing unit 55 allows the DMA unit to access the RAM 53 to read the image data of the processing object from the RAM 53, allows the ALU to perform the calculation on the image data according to the content of the calculation process, and allows the DMA unit to transmit the calculation-resulting image data, which become the calculation result, to the RAM 53. As a result, the calculation-resulting image data are stored in the RAM 53. Next, the parallel calculation processing unit 55 notifies the CPU 52 of the completion of the calculation process through the internal I/F 56 by interruption or the like.

The sequential calculation processing unit 54 is a calculation process circuit which can perform a calculation process in a sequential manner at a high speed. The sequential calculation processing unit 54 includes a calculation unit, a DMA unit, and a storage unit. Furthermore, the calculation processes which are to be sequentially performed denote processes performed for each of the pixel data. As a representative calculation process included in the image processing, there is, for example, an error diffusion process where the calculation result is propagated to the next pixel. Furthermore, besides the image processing, the term “sequentially” denotes that a general computer program sequentially performs commands. The storage unit stores various programs for allowing the sequential calculation processing unit 54 to perform a calculation process on the image data. The program is transmitted from the CPU 52 through the internal I/F 56. In addition, the storage unit stores a sequential calculation process ability table listing calculation processes which can be performed by the sequential calculation processing unit 54. For example, the sequential calculation process ability table lists calculation numbers of the calculation processes which can be performed by the sequential calculation processing unit 54 and acceptability states indicated whether or not the calculation processes can be accepted in a correspondence manner. For example, the state where the calculation process cannot be accepted is a state where the sequential calculation processing unit 54 has already been performing a calculation process and thus other calculation processes cannot be performed. The DMA unit accesses the RAM 53 without intervention of the CPU 52 to read image data stored in the RAM 53 or to write the result (calculation result) of the calculation performed by the calculation unit. The calculation unit is input with the image data of the processing object read from the RAM 53 by the DMA unit, and the calculation unit performs the aforementioned sequential calculation processes on the image data. In this configuration, if the sequential calculation processing unit 54 receives the calculation process information transmitted through the internal I/F 56 by the CPU 52, the sequential calculation processing unit 54 determines, with reference to the sequential calculation process ability table, whether or not the calculation process of the calculation number indicated by the calculation process information can be performed and whether or not the calculation process can be received. In the case where the result of determination is affirmative, the sequential calculation processing unit 54 allows the DMA unit to access the RAM 53 to read the image data of the processing object from the RAM 53, allows the calculation unit to perform the calculation on the image data in a pipeline manner according to the content of the calculation process, and allows the DMA unit to transmit the calculation-resulting image data to the RAM 53. As a result, the calculation-resulting image data are written and stored in the RAM 53. Next, the sequential calculation processing unit 54 notifies the CPU 52 of the completion of the calculation process through the internal I/F 56 by interruption or the like.

As the components for implementing the sequential calculation processing unit 54, there are hardware circuits (ASIC and FPGA), devices where calculation elements such as ALUs are connected in a pipeline manner, a processor in for improving parallel performance a VLIW manner, and the like. In the case of performing the calculation process included in the image processing, the hardware circuits are effective. In the case of performing various kinds of image processing, an FPGA which is adaptable to a change in circuit is preferred to completely fixed ASIC. In addition, if a circuit on the FPGA is a device which can be rewritable after the device is powered on, the circuit is preferable in that a larger number of processes can be performed. In the case in which the sequential calculation processing unit 54 is configured by the FPGA which can rewrite a circuit, it is preferable that the CPU 52 should have a function of determining by itself whether or not the FPGA can accept the image data of the processing object after the CPU 52 transmits the calculation process information to the sequential calculation processing unit 54 and after the rewriting of the circuit is completed. Configuration information for rewriting the circuits may be stored in a flash memory connected to or embedded in the FPGA. Otherwise, the rewriting of the circuits may be implemented by the CPU 52 writing the configuration information.

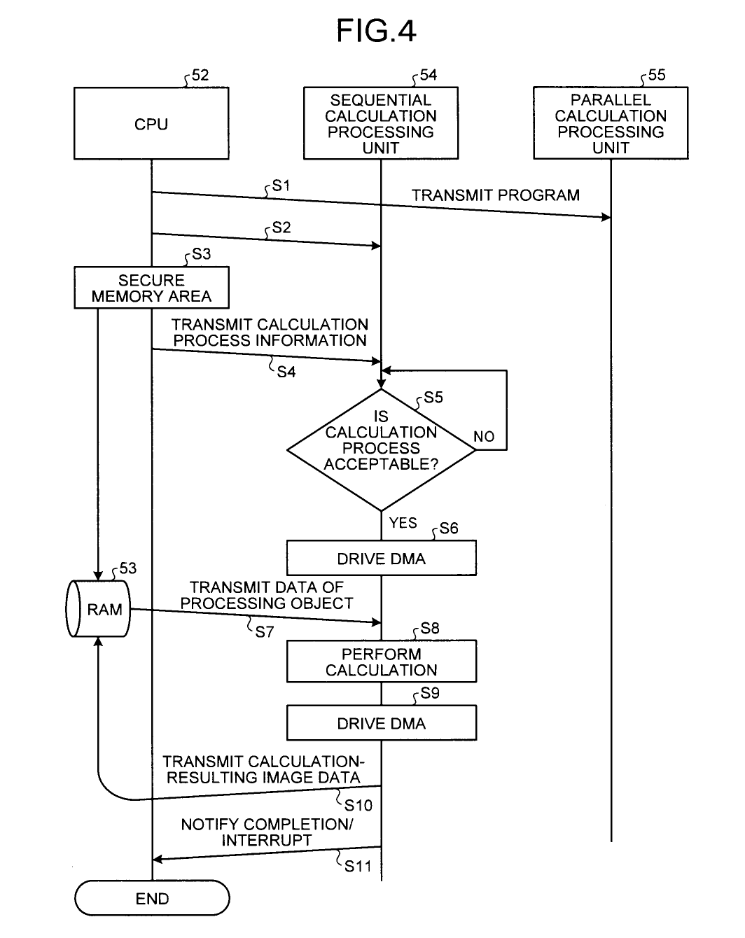

Next, a procedure of processes performed by the high-speed calculation unit 51 according to the embodiment is described with reference to FIG. 4. At the time of driving the high-speed calculation unit 51, the CPU 52 transmits the program for performing the calculation process included in the image processing to the parallel calculation processing unit 55 (Step S1), and transmits the program for performing the calculation process included in the image processing to the sequential calculation processing unit 54 (Step S2). Next, if the CPU 52 is input with the image data and the command for performing the image processing on the image data, the CPU 52 secures a memory area for storing the image data and the after-image-processing image data in the RAM 53 (Step S3). Next, the CPU 52 determines, as a calculation performer, any one of the CPU 52, the sequential calculation processing unit 54, and the parallel calculation processing unit 55 indicated by the calculation performer information that corresponds to the calculation process number of each calculation process, with reference to the calculation process correspondence table, for the calculation processes included in the image processing which is commented to be performed. Herein, the sequential calculation processing unit 54 is determined as the calculation performer. In this case, the CPU 52 transmits the calculation process information indicating the content of the calculation process to the sequential calculation processing unit 54 (Step S4).

If the sequential calculation processing unit 54 receives the calculation process information transmitted by the CPU 52, the sequential calculation processing unit 54 determines, with reference to the sequential calculation process ability table, whether or not the calculation process of the calculation number indicated by the calculation process information can be performed and whether or not the calculation process can be received (Step S5). In the case where the result of determination is affirmative (Yes at Step S5), the sequential calculation processing unit 54 drives the DMA unit (Step S6) to access the RAM 53 to read the image data of the processing object from the RAM 53 (Step S7). Next, the sequential calculation processing unit 54 performs the calculation on the image data according to the content of the calculation process indicated by the calculation process information (Step S8). If the calculation is completed, the sequential calculation processing unit 54 drives the DMA unit (Step S9) to transmit the calculation-resulting image data to the RAM 53 (Step S10). As a result, the calculation-resulting image data are written and stored in the RAM 53. Next, the sequential calculation processing unit 54 notifies the completion of the calculation process to the CPU 52 (Step S11).

Furthermore, in the case where the parallel calculation processing unit 55 is determined as the calculation performer, Step S3 is performed with respect to the parallel calculation processing unit 55, so that Steps S4 to S11 are performed by the parallel calculation processing unit 55.

According to the above configuration, with respect to the image processing of which load is large and which is complicated, the CPU 52 allows the parallel calculation processing unit 55 to perform the calculation processes, which can be performed in parallel, and allows the sequential calculation processing unit 54 to perform the calculation processes, which can be performed sequentially, in a pipeline manner. Therefore, it is possible to perform complicated calculation processes or various calculation process dedicated to the CPU at high speed.

### Second Embodiment

Next, an information processing apparatus and an information processing method according to a second embodiment are described. In addition, the same elements as those of the aforementioned first embodiment are denoted by the same reference numerals, and the description thereof is not repeated.

In the above first embodiment, in the case where the processing speed of the CPU 52 is high and the load of the CPU 52 is low at the time of performing the image processing, neither the sequential calculation processing unit 54 nor the parallel calculation processing unit 55 performs the calculation processes at high speed, but only the CPU 52 may perform the calculation process at high speed and the time corresponding to the calculation process may be shortened. In the embodiment, in this case, the CPU 52 performs the calculation process. Further, for each of the plurality of different calculation processes included in the image processing, the CPU 52 determines the calculation performs for each calculation process according to the load situations and the calculation process capabilities of the CPU 52, the sequential calculation processing unit 54, and the parallel calculation processing unit 55, and also determines the performing order of the calculation processes so that time for the plurality of different calculation processes may be shortest.

Now, a hardware configuration and a functional configuration of the high-speed calculation unit 51 according to the embodiment are described with reference to FIG. 6. The CPU 52 has functions of the calculation site determination unit and the load calculation unit. Each of the sequential calculation processing unit 54 and the parallel calculation processing unit 55 has a function of each load calculation unit. The RAM 53 stores the calculation process capability of each of the CPU 52, the sequential calculation processing unit 54, and the parallel calculation processing unit 55, for each of the calculation process included in the image processing. The load calculation unit of the CPU 52 calculates the load amount of the CPU 52. The load calculation unit of the sequential calculation processing unit 54 calculates the load amount of the sequential calculation processing unit 54. The load calculation unit of the parallel calculation processing unit 55 calculates the load amount of the parallel calculation processing unit 55. The calculation site determination unit determines which of the CPU 52, the sequential calculation processing unit 54, and the parallel calculation processing unit 55 is to be set as the calculation performer for each of the calculation processes included in the image processing by using the load amount of the CPU 52, the load amount of the sequential calculation processing unit 54, and the load amount of the parallel calculation processing unit 55, and the calculation process capabilities of the CPU 52, the sequential calculation processing unit 54, and the parallel calculation processing unit 55, for the calculation processes stored in the RAM 53 and determines the performing order of the calculation processes so that time for the plurality of the calculation processes may be shortest.

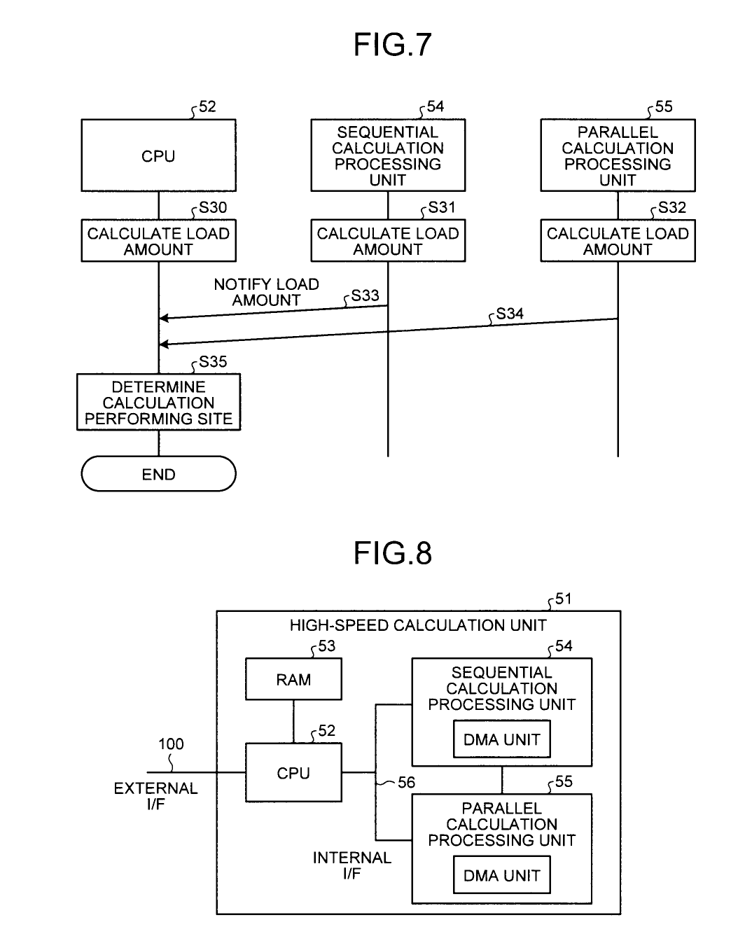

Next, the procedure for the calculation site determination process according to the embodiment is described with reference to FIG. 7. The CPU 52 calculates a load amount thereof (Step S30). The sequential calculation processing unit 54 calculates a load amount thereof (Step S31) and notifies the load amount to the CPU 52 through the internal I/F 56 (Step S33). The parallel calculation processing unit 55 calculates a load amount thereof (Step S32) and notifies the load amount to the CPU 52 through the internal I/F 56 (Step S34). The CPU 52 determines which of the CPU 52, the sequential calculation processing unit 54, and the parallel calculation processing unit 55 is to be set as the calculation performer to perform the calculation process included in the image processing by using the load amount obtained through the calculation at Step S30, the load amount of the sequential calculation processing unit 54 notified at Step S33, the load amount of the parallel calculation processing unit 55 notified at Step S34, and the calculation process capabilities of the CPU 52, the sequential calculation processing unit 54, and the parallel calculation processing unit 55, for the calculation processes stored in the RAM 53, and determines the performing order of the calculation processes (Step S35). For example, in the case where different calculation processes A, B, and C are included in the image processing, the CPU 52 determines the CPU 52 as the calculation performer for the calculation process A, the parallel calculation processing unit 55 as the calculation performer for the calculation process B, and the sequential calculation processing unit 54 as the calculation performer for the calculation process C. The CPU 52 also determines the performing order in a manner of performing the calculation process A, the calculation process B, and the calculation process C in this order. Next, in order for the calculation processes to be performed in this order, after the CPU 52 completes the performing of the calculation process A, as described at Steps S4 to S11 of FIG. 4, the CPU 52 transmits the calculation process information on the calculation process B to the parallel calculation processing unit 55 and allows the parallel calculation processing unit 55 to perform the calculation process B. If the completion of the calculation process is notified by the parallel calculation processing unit 55, similarly, the CPU 52 transmits the calculation process information on the calculation process C to the sequential calculation processing unit 54 and allows the sequential calculation processing unit 54 to perform the calculation process C.

Furthermore, in the aforementioned example, although the calculation performer is changed for every calculation process, the calculation performer also may be changed for each portion of one calculation process. In other words, one calculation process may be performed by the CPU 52 and the sequential calculation processing unit 54 in a divisional manner, or one calculation process may be performed by the CPU 52 and the parallel calculation processing unit 55 in a divisional manner. In this case, it is preferable that the CPU 52 should be configured to change the data amount of the image data of the object, on which the calculation process is performed in a divisional manner, according to the load amounts of the calculation performers.

According to the above configuration, it is possible to perform complicated calculation processes or various calculation processes dedicated to a CPU at higher speed.

### Third Embodiment

Next, an information processing apparatus and an information processing method according to a third embodiment are described. In addition, the same elements as those of the aforementioned first and second embodiments are denoted by the same reference numerals, and the description thereof is not repeated.

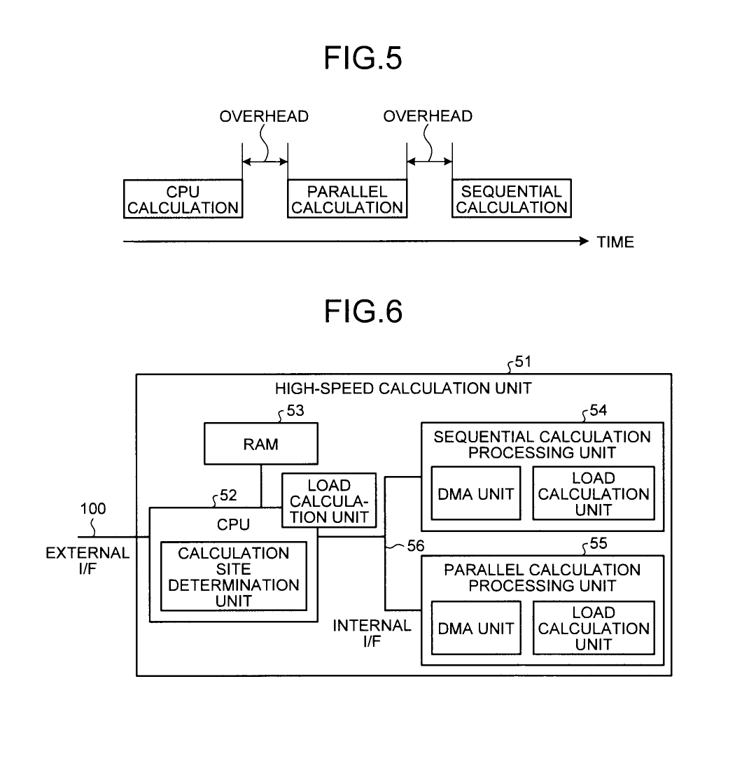

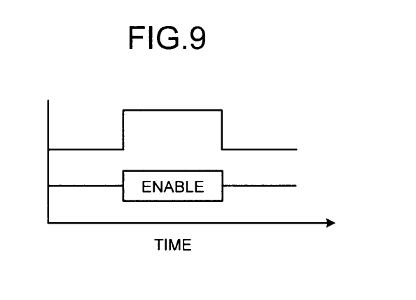

As described in the first embodiment, in the case where the different calculation processing units including the CPU 52, the sequential calculation processing unit 54, and the parallel calculation processing unit 55, are connected to each other to perform the calculation process, so that overhead involving reception and transmission of the image data between the calculation processing units and various controls may occur as well as the processing times taken in the respective calculation processing unit (refer to FIG. 5) are required. This also becomes an important factor of determining the throughput performance of the high-speed calculation unit 51. In addition, in the configuration of the high-speed calculation unit 51 according to the first embodiment illustrated in FIG. 2, in the case where the sequential calculation processing unit 54 performs a calculation process after the parallel calculation processing unit 55 performs a calculation process, the resulting image data obtained by the calculation process of the parallel calculation processing unit 55 needs to be temporarily written in the RAM 53. Therefore, the calculation process performed by the parallel calculation processing unit 55 and the calculation process performed by the sequential calculation processing unit 54 are sequentially performed. In the embodiment, the calculation process performed by the parallel calculation processing unit 55 and the calculation process performed by the sequential calculation processing unit 54 are configured so as to be continuously performed. Now, a hardware configuration of the high-speed calculation unit 51 according to the embodiment is described with reference to FIG. 8. As illustrated in the figure, the sequential calculation processing unit 54 and the parallel calculation processing unit 55 are connected to each other via an internal bus, so that the sequential calculation processing unit 54 and the parallel calculation processing unit 55 can receive and transmit the image data via the internal bus. The reception and transmission of the image data are performed by parallel signals as illustrated in, for example, FIG. 9. Furthermore, the communication direction between the sequential calculation processing unit 54 and the parallel calculation processing unit 55 may be unidirectional from the former to the latter or vice versa, or bidirectional.

The CPU 52 determines, as the calculation performer, any one of the CPU 52, the sequential calculation processing unit 54, and the parallel calculation processing unit 55 indicated by the calculation performer information corresponding to the calculation process number of each calculation process, with reference to the calculation process correspondence table, for the calculation processes included in the image processing of which the performing is commanded, and the CPU 52 determines performing order of the calculation processes. The performing order of the calculation processes may be set in advance, and otherwise, the performing order of the calculation processes may be determined by a function of the calculation site determination unit described in the second embodiment. Next, the CPU 52 transmits the calculation process information indicating the content of the calculation process which is to be performed by the sequential calculation processing unit 54, and indicating the input source of the image data of the processing object and the output site of the calculation-resulting image data to the sequential calculation processing unit 54. The CPU 52 transmits the calculation process information indicating the content of the calculation process that is to be performed by the parallel calculation processing unit 55, and indicating the input source of the image data of the processing object and the output site of the calculation-resulting image data to the parallel calculation processing unit 55. The calculation process information indicates, for example, the input source of the image data of the processing object and the output site of the calculation-resulting image data in addition to calculation process number, codes representing the content of the calculation process, data size of the image data of the processing object, and parameters used for the calculation process exemplarily illustrated in FIG. 3. The input source of the image data of the processing object and the output site of the calculation-resulting image data are one of the RAM 53, the sequential calculation processing unit 54, and the parallel calculation processing unit 55.

If the sequential calculation processing unit 54 receives the calculation process information transmitted by the CPU 52, the sequential calculation processing unit 54 determines, with reference to the sequential calculation process ability table, whether or not the calculation process of the calculation process number indicated by the calculation process information can be performed. In the case where the result of determination is affirmative, the sequential calculation processing unit 54 acquires the image data from the input source indicated by the calculation process information. In the case where the input source is the RAM 53, similarly to the first embodiment, the sequential calculation processing unit 54 allows the DMA unit to access the RAM 53 and reads the image data of the processing object from the RAM 53. In addition, in the case where the input source is the parallel calculation processing unit 55, the sequential calculation processing unit 54 receives the image data of the processing object from the parallel calculation processing unit 55 through the internal bus. Next, the sequential calculation processing unit 54 allows the calculation unit to perform the calculation process on the image data according to the content of the calculation process and transmits the calculation-resulting image data to the output site indicated by the calculation process information. In the case where the output site is the RAM 53, similarly to the first embodiment, the sequential calculation processing unit 54 allows the DMA unit to transmit the calculation-resulting image data to the RAM 53 and to notify the completion of the calculation process to the CPU 52. In addition, in the case where the output site is the parallel calculation processing unit 55, the sequential calculation processing unit 54 transmits the calculation-resulting image data to the parallel calculation processing unit 55 through the internal bus.

If the parallel calculation processing unit 55 receives the calculation process information transmitted by the CPU 52, the parallel calculation processing unit 55 determines with reference to the sequential calculation process ability table whether or not the calculation process of the calculation number indicated by the calculation process information can be performed. In the case where the result of determination is affirmative, the sequential calculation processing unit 54 acquires the image data from the input source indicated by the calculation process information. In the case where the input source is the RAM 53, similarly to the first embodiment, the parallel calculation processing unit 55 allows the DMA unit to access the RAM 53 to read the image data of the processing object from the RAM 53. In addition, in the case where the input source is the sequential calculation processing unit 54, the parallel calculation processing unit 55 receives the image data of the processing object from the sequential calculation processing unit 54 through the internal bus. Next, the parallel calculation processing unit 55 allows the calculation unit to perform the calculation process on the image data according to the content of the calculation process and transmits the calculation-resulting image data to the output site indicated by the calculation process information. In the case of the output site is the RAM 53, similarly to the first embodiment, the parallel calculation processing unit 55 allows the DMA unit to transmit the calculation-resulting image data to the RAM 53 and to notify the completion of the calculation process to the CPU 52. In addition, in the case where the output site is the sequential calculation processing unit 54, the parallel calculation processing unit 55 transmits the calculation-resulting image data to the sequential calculation processing unit 54 through the internal bus.

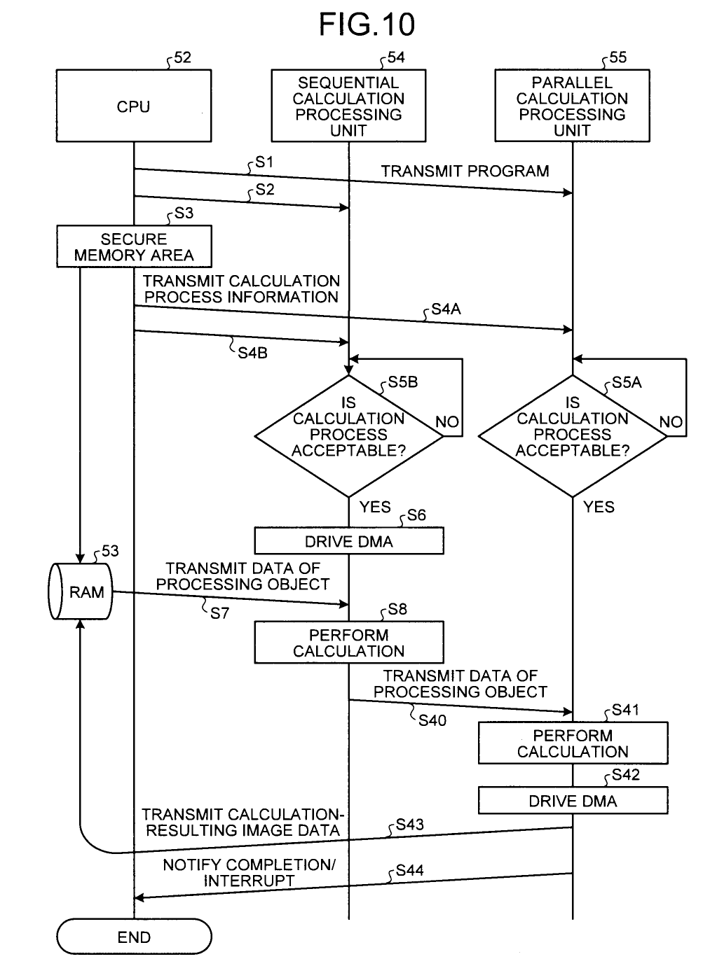

Next, a procedure of processes performed by the high-speed calculation unit 51 according to the embodiment is described with reference to FIG. 10. Step S1 to S3 are the same as those of the first embodiment. Next, similarly to the first and second embodiments, the CPU 52 determines the calculation performer for the calculation processes included in the image processing that is commanded to be done, and the CPU 52 determines performing order of the calculation processes. In this case, two calculation processes are included in the image processing; the calculation performer of the one calculation process is determined to be the sequential calculation processing unit 54, and the calculation performer of the other calculation process is determined to be the parallel calculation processing unit 55. In addition, it is determined that, after the one calculation process is performed by the sequential calculation processing unit 54, the other calculation process is performed by the parallel calculation processing unit 55. Next, at Step S4B, the CPU 52 transmits calculation process information indicating the content of the one calculation process and indicating that the input source of the image data of the processing object is the RAM 53 and the output site of the calculation-resulting image data is the parallel calculation processing unit 55, to the sequential calculation processing unit 54. In addition, at Step S4A, the CPU 52 transmits calculation process information indicating the content of the other calculation process and indicating that the input source of the image data of the processing object is the sequential calculation processing unit 54 and the output site of the calculation-resulting image data is the RAM 53, to the parallel calculation processing unit 55.

Steps S5A to S5B and Steps S6 to S8 are the same as those of the first embodiment. Furthermore, at Step S6, although the sequential calculation processing unit 54 acquires the image data from the input source indicated by the calculation process information, since the input source is the RAM 53, similarly to the first embodiment, the image data of the processing object are read from the RAM 53. At Step S40, the sequential calculation processing unit 54 transmits the calculation-resulting image data to the parallel calculation processing unit 55 which is the output site indicated by the calculation process information. At Step S41, in the case where the determination result of Step S5A is affirmative, if the parallel calculation processing unit 55 receives the image data transmitted from the sequential calculation processing unit 54 which is the input source indicated by the calculation process information, the parallel calculation processing unit 55 performs the calculation process on the image data according to the content of the calculation process indicated by the calculation process information. In this case, since the RAM 53 is the output site indicated by the calculation process information, if the calculation process is completed, the parallel calculation processing unit 55 drives the DMA unit (Step S42) and transmits the calculation-resulting image data to the RAM 53 (Step S43). Next, the parallel calculation processing unit 55 notifies the completion of the calculation process to the CPU 52 (Step S44).

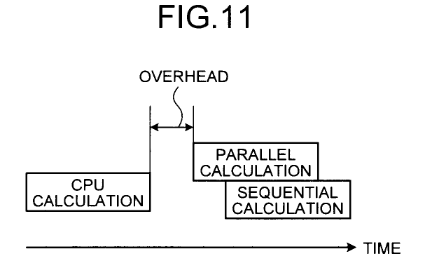

According to the above configuration, it is possible to continuously perform the calculation process performed by the parallel calculation processing unit 55 and the calculation process performed by the sequential calculation processing unit 54, and as illustrated in FIG. 11, it is possible to reduce overhead in comparison with the first embodiment. Therefore, it is possible to perform complicated calculation processes or various calculation processes dedicated to a CPU at higher speed.

### Modification

In addition, the present invention is not limited to the aforementioned embodiments, but the components thereof may be modified without departing from the concept of the structure in the implementation stage thereof. In addition, various modifications of the present invention can be formed in combination of a plurality of the components disclosed in the aforementioned embodiments. For example, some components may be omitted from the all components in the embodiments. In addition, the components of different embodiments may be appropriately combined. In addition, various available modifications may be exemplified as follows.

In the aforementioned embodiments, various programs performed by the CPU 52 may be configured to be stored in a computer connected to a network such as the Internet and to be downloaded through the network. In addition, the various programs may be configured to be recorded as a file in an installable format or an executable format in a computer-readable recording medium such as a CD-ROM, a flexible disk (FD), a CD-R, or a DVD (Digital Versatile Disk). The same configuration may be available to the various programs performed by the sequential calculation processing unit 54 and the various programs performed by the parallel calculation processing unit 55.

In the aforementioned embodiments, the image forming apparatus can be configured to include the image processing unit 50. The image processing unit 50 may be configured to implement at least one of, for example, a copier function, a printer function, a scanner function, and a facsimile function.

In the aforementioned embodiments, although the sequential calculation processing unit 54 and the parallel calculation processing unit 55 are configured to transmit notices of the completion of the calculation process to the CPU 52, the present invention is not limited thereto. For example, registers to which the CPU 52 can gain an access through the internal I/F 56 are provided; the sequential calculation processing unit 54 writes the state of the performing of the calculation process in the registers; and the CPU 52 monitors the registers, so that the CPU 52 may be configured to determine the completion of the calculation process. The same configuration may be available to the parallel calculation processing unit 55.

In the aforementioned embodiments, although the calculation performer is configured to be changed for each calculation process, the calculation performer may be configured to be changed for each portion of one calculation process. In other words, one calculation process may be performed by the CPU 52 and the sequential calculation processing unit 54 in a divisional manner, or one calculation process may be performed by the CPU 52 and the parallel calculation processing unit 55 in a divisional manner. In this case, it is preferable that the CPU 52 should be configured to change the data amount of the image data of the object, on which the calculation process is performed in a divisional manner, according to the load amounts of the calculation performers.

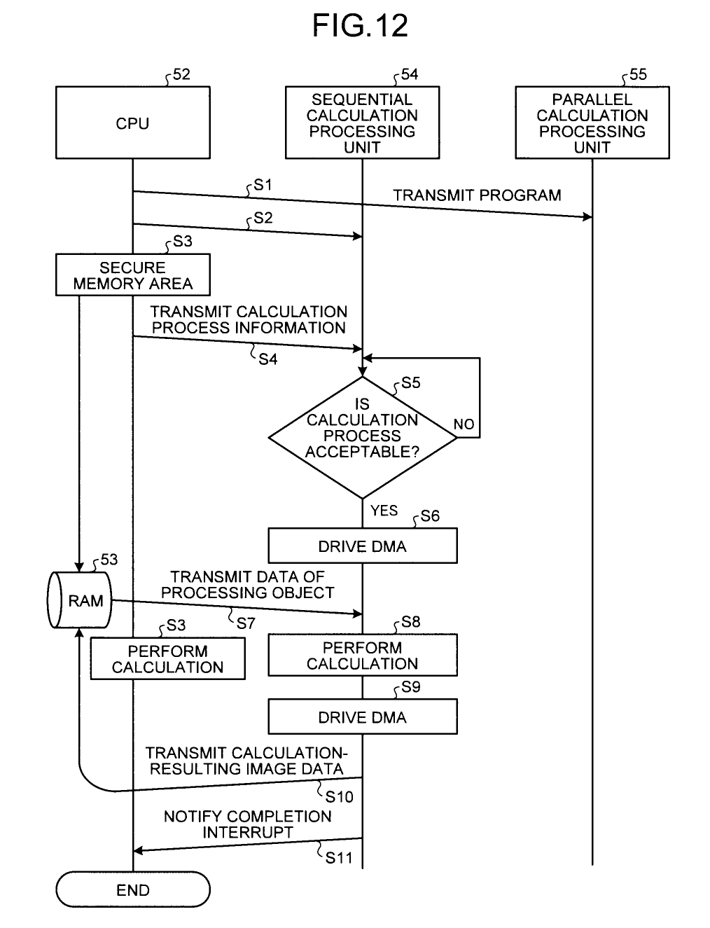

More specifically, for example, if the calculation process performed by the sequential calculation processing unit 54 or the calculation process performed by the parallel calculation processing unit 55 can be performed by the CPU 52 at Step S8 of FIG. 4, the calculation process may be configured to be performed in parallel with Step S8. In other words, the CPU 52 determines, according to a predetermined condition, whether the CPU 52 and the sequential calculation processing unit 54 perform the one calculation process, or the CPU 52 and the parallel calculation processing unit 55 perform the one calculation process, and the CPU 52 determines a portion of the image data on which calculation is to be performed by one calculation performer, and another portion of the image data on which calculation is to be performed by the other calculation performer. In this case, the predetermined condition may be the same as that of the aforementioned first embodiment or as that of the aforementioned second embodiment. In addition, with respect to the method of determining the portions of the image data to the calculation performers, for example, the image data may be divided according to a predetermined ratio so that the divided image data may be allocated. Otherwise, the image data may be divided according to the load amounts or the calculation process capabilities described in the aforementioned second embodiment so that the divided image data may be allocated. Next, a procedure of processes performed by the high-speed calculation unit 51 according to the modified example is described with reference to FIG. 12. Steps S1 to S6 are the same as those of the first embodiment. However, at Step S4, the CPU 52 designates the calculation process information so that the sequential calculation processing unit 54 performs the calculation process on some portion of the image data of the processing object, and the CPU 52 transmits the calculation process information to the sequential calculation processing unit 54. Next, at Step S7, the sequential calculation processing unit 54 reads some portion of the image data of the processing object designated in the calculation process information from the RAM 53, and at Step S8, the sequential calculation processing unit 54 performs the calculation process on the image data. Steps S9 to S11 are the same as those of the first embodiment. On the other hand, the CPU 52 performs the calculation process on the image processing data of the portion excluding some of the image data of the processing object at Step S20. The same configuration may be available to the calculation process performed by the parallel calculation processing unit 55. According to the above configuration, it is possible to perform complicated calculation processes or various calculation processes dedicated to a CPU at higher speed.

In the aforementioned second embodiment, a means of connecting the sequential calculation processing unit 54 to the parallel calculation processing unit 55 is not limited to the internal bus, but general-purpose interfaces such as a PCI bus or a PCI express may be used. In addition, communication between the sequential calculation processing unit 54 and the parallel calculation processing unit 55 may be implemented, for example, in a packet manner.

According to the present invention, in an information processing apparatus including a parallel calculation processing unit and sequential calculation processing unit, it is possible to perform complicated calculation processes or various calculation processes at high speed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a storage unit which stores first image data including a plurality of pixel data;
a control unit which is connected to the storage unit and which performs a calculation process on the first image data and controls performing of the calculation process;
a parallel calculation process unit which simultaneously performs the same calculation processes on entirety of or some of the plurality of the pixel data included in the first image data; and
a sequential calculation process unit which performs the calculation process on each of the pixel data included in the first image data,
wherein the control unit determines, as a calculation performer to perform a first calculation process, at least one unit selected from a group including the control unit itself, the parallel calculation process unit, and the sequential calculation process unit, according to a predetermined condition.

2. The information processing apparatus according to claim 1,
wherein
the control unit includes a transmitting unit
which transmits calculation process information indicating content of the first calculation process to the parallel calculation process unit, when the control unit determines the parallel calculation process unit as the calculation performer to perform the first calculation process, and
which transmits the calculation process information to the sequential calculation process unit, when the control unit determines the sequential calculation process unit as the calculation performer to perform the first calculation process,
wherein
each of the parallel calculation process unit and the sequential calculation process unit includes:
a calculation process information receiving unit which receives the calculation process information transmitted from the transmitting unit;
a determination unit which determines whether or not the first calculation process, indicated by the calculation process information received by the calculation process information receiving unit, can be received;
a direct memory access unit which gains a direct memory access to the storage unit, when the determination result of the determination unit is affirmative to read the first image data;
a performing unit which performs the first calculation process on the first image data read by the direct memory access unit.

3. The information processing apparatus according to claim 2,
wherein the direct memory access unit writes second image data, which is the resulting data from the first calculation process, in the storage unit.

4. The information processing apparatus according to claim 2,
wherein each of the parallel calculation process unit and the sequential calculation process unit further includes a notifying unit which notifies completion of the first calculation process to the control unit when the first calculation process performed by the performing unit is completed.

5. The information processing apparatus according to claim 1,
wherein the control unit
determines the control unit and the sequential calculation process unit as calculation performers to perform a second calculation process according to a predetermined condition, for the second calculation process, and
determines
a portion of the first image data on which the second calculation process is to be performed by the control unit and
a portion of the first image data on which the second calculation process is to be performed by the sequential calculation process unit.

6. The information processing apparatus according to claim 1,
wherein the control unit
determines the control unit and the parallel calculation process unit as calculation performers to perform a second calculation process according to a predetermined condition, for the second calculation process, and
determines
a portion of the first image data on which the second calculation process is to be performed by the control unit and
a portion of the first image data on which the second calculation process is to be performed by the parallel calculation process unit.

7. The information processing apparatus according to claim 2,
wherein the control unit includes
a calculation site determination unit which
determines a calculation performer for each calculation process according to load situations and calculation process capabilities of the control unit, the parallel calculation process unit, and the sequential calculation process unit for a plurality of different calculation processes and
determines performing order of the calculation processes so that time taken to perform the plurality of the calculation processes becomes the shortest, and
wherein the transmitting unit transmits the calculation process information
to the calculation performer to perform each calculation process and
to at least one of the parallel calculation process unit and the sequential calculation process unit, which are determined by the calculation site determination unit according to the performing order determined by the calculation site determination unit.

8. The information processing apparatus according to claim 2,
wherein the parallel calculation process unit further includes a first interface unit transmitting second image data, which is the resulting data from the calculation process, to the sequential calculation process unit.

9. The information processing apparatus according to claim 5,
wherein the parallel calculation process unit further includes a first interface unit transmitting second image data, which is the resulting data from the calculation process, to the sequential calculation process unit.

10. The information processing apparatus according to claim 6,
wherein the parallel calculation process unit further includes a first interface unit transmitting second image data, which is the resulting data from the calculation process, to the sequential calculation process unit.

11. The information processing apparatus according to claim 8,
wherein the control unit
determines at least one of the control unit, the parallel calculation process unit, and the sequential calculation process unit, as a calculation performer to perform each calculation process, according to a predetermined condition, for a plurality of the different calculation processes and
determines performing order of the calculation processes,
wherein the transmitting unit
transmits, according to the performing order determined by the calculation site determination unit, calculation process information
indicating that the parallel calculation process unit is the calculation performer and
indicating content of the calculation process determined by the first determination unit, an input source of third image data as an object of the calculation process, and an output site of fourth image data, which is the resulting data from the calculation process, to the parallel calculation process unit and
transmits calculation process information
indicating the sequential calculation process unit is the calculation performer and
indicating content of the calculation process determined by the first determination unit, an input source of fifth image data as an object of the calculation process, and an output site of sixth image data, which is the resulting data from the calculation process, to the sequential calculation process unit,
wherein the parallel calculation process unit includes an image data receiving unit which receives the second image data as the image data of the processing object through the first interface unit, when the input source indicated by the calculation process information is the sequential calculation process unit, and
wherein the sequential calculation process unit includes an image data transmitting unit which transmits the second image data through the first interface unit, when the output site indicated by the calculation process information is the parallel calculation process unit.

12. The information processing apparatus according to claim 9,
wherein the control unit
determines at least one of the control unit, the parallel calculation process unit, and the sequential calculation process unit, as a calculation performer to perform each calculation process, according to a predetermined condition, for a plurality of the different calculation processes and
determines performing order of the calculation processes,
wherein the transmitting unit
transmits, according to the performing order determined by the calculation site determination unit, calculation process information
indicating that the parallel calculation process unit is the calculation performer and
indicating content of the calculation process determined by the first determination unit, an input source of third image data as an object of the calculation process, and an output site of fourth image data, which is the resulting data from the calculation process, to the parallel calculation process unit and
transmits calculation process information
indicating the sequential calculation process unit is the calculation performer and
indicating content of the calculation process determined by the first determination unit, an input source of fifth image data as an object of the calculation process, and an output site of sixth image data, which is the resulting data from the calculation process, to the sequential calculation process unit,
wherein the parallel calculation process unit includes an image data receiving unit which receives the second image data as the image data of the processing object through the first interface unit, when the input source indicated by the calculation process information is the sequential calculation process unit, and
wherein the sequential calculation process unit includes an image data transmitting unit which transmits the second image data through the first interface unit, when the output site indicated by the calculation process information is the parallel calculation process unit.

13. The information processing apparatus according to claim 10,
wherein the control unit
determines at least one of the control unit, the parallel calculation process unit, and the sequential calculation process unit, as a calculation performer to perform each calculation process, according to a predetermined condition, for a plurality of the different calculation processes and
determines performing order of the calculation processes,
wherein the transmitting unit
transmits, according to the performing order determined by the calculation site determination unit, calculation process information
indicating that the parallel calculation process unit is the calculation performer and
indicating content of the calculation process determined by the first determination unit, an input source of third image data as an object of the calculation process, and an output site of fourth image data, which is the resulting data from the calculation process, to the parallel calculation process unit and
transmits calculation process information
indicating the sequential calculation process unit is the calculation performer and
indicating content of the calculation process determined by the first determination unit, an input source of fifth image data as an object of the calculation process, and an output site of sixth image data, which is the resulting data from the calculation process, to the sequential calculation process unit,
wherein the parallel calculation process unit includes an image data receiving unit which receives the second image data as the image data of the processing object through the first interface unit, when the input source indicated by the calculation process information is the sequential calculation process unit, and
wherein the sequential calculation process unit includes an image data transmitting unit which transmits the second image data through the first interface unit, when the output site indicated by the calculation process information is the parallel calculation process unit.

14. The information processing apparatus according to claim 2,
wherein the sequential calculation process unit further includes a second interface unit that transmits second image data, which is the resulting data from the calculation process, to the parallel calculation process unit.

15. The information processing apparatus according to claim 5,
wherein the sequential calculation process unit further includes a second interface unit that transmits second image data, which is the resulting data from the calculation process, to the parallel calculation process unit.

16. The information processing apparatus according to claim 6,
wherein the sequential calculation process unit further includes a second interface unit that transmits second image data, which is the resulting data from the calculation process, to the parallel calculation process unit.

17. The information processing apparatus according to claim 8,
wherein the control unit
determines at least one of the control unit, the parallel calculation process unit and the sequential calculation process unit as a calculation performer to perform each calculation process according to a predetermined condition for a plurality of the different calculation processes and
determines performing order of the calculation processes,
wherein the transmitting unit, according to the performing order determined by the calculation site determination unit,
transmits calculation process information
indicating that the parallel calculation process unit is the calculation performer and
indicating content of the calculation process determined by the first determination unit, an input source of third image data as an object of the calculation process, and an output site of fourth image data, which is the resulting data from the calculation process, to the parallel calculation process unit and
transmits calculation process information
indicating the sequential calculation process unit is the calculation performer and
indicating content of the calculation process determined by the first determination unit, an input source of fifth image data as an object of the calculation process, and an output site of sixth image data, which is the resulting data from the calculation process, to the sequential calculation process unit,
wherein the parallel calculation process unit includes an image data transmitting unit which transmits the second image data as the image data of the processing object through the second interface unit, when the output site indicated by the calculation process information is the sequential calculation process unit, and
wherein the sequential calculation process unit includes an image data receiving unit which receives the second image data as the image data of the processing object through the second interface unit, when the input source indicated by the calculation process information is the parallel calculation process unit.

18. The information processing apparatus according to claim 1, wherein the sequential calculation process unit is configured with hardware capable of rewriting a circuit.

19. An image forming apparatus comprising:
the information processing apparatus according to claim 1; and
an image forming unit which forms an image on a printing medium by using the second image data, which is the resulting data from the calculation process.

20. A method of processing information performed by an information processing apparatus including:
a storage unit which stores image data including a plurality of pixel data,
a control unit which is connected to the storage unit and which can perform a calculation process on the image data and controls the performing of the calculation process,
a parallel calculation process unit which simultaneously performs the same calculation processes on the entire or some of the plurality of the pixel data included in the image data, and
a sequential calculation process unit which performs the calculation process on each of the pixel data included in the image data,
the method comprising:
allowing the control unit to determine at least one out of the control unit, the parallel calculation process unit, and the sequential calculation process unit, as a calculation performer to perform the first calculation process according to a predetermined condition.
